(19) United States
(12) Patent Application Publication
(10) Pub. No.: US 2026/0088012 A1
(43) Pub. Date: Mar. 26, 2026

(54) SYSTEMS AND METHODS FOR OPERATING AN AUDIO SYSTEM OF A DOMESTIC APPLIANCE

(71) Applicant: Haier US Appliance Solutions, Inc., Wilmington, DE (US)

(72) Inventors: Christopher Hayward Osborne, Louisville, KY (US); Joseph Thomas Waugh, Louisville, KY (US)

(21) Appl. No.: 18/897,406

(22) Filed: Sep. 26, 2024

(51) Int. Cl. G10K 11/178; H04R 1/02

(52) U.S. Cl. CPC G10K 11/1783; G10K 2210/105; H04R 1/028

(57) ABSTRACT

A method of operating an audio system of a domestic appliance may include directing operation of the audio system. The method may include determining noise produced during operation of appliance components. The method may include implementing a responsive action at the audio system to adjust acoustic parameters of the audio system in response to determining noise produced during operation of appliance components.

### FIELD OF THE DISCLOSURE

The present subject matter relates generally to a domestic appliance, and more particularly to an audio system of a domestic appliance.

### BACKGROUND OF THE DISCLOSURE

Domestic (e.g., household) appliances are used generally for a variety of tasks by a variety of users. For example, a household may include such appliances as laundry appliances (e.g., a washing machine or dryer appliance), kitchen appliances (e.g., a refrigerator, an oven, a cooktop, a range hood, a microwave, dishwasher, etc.), along with air conditioners, water heaters, or various other appliances.

Many domestic appliances include audio systems that are capable of receiving and outputting audio content (e.g., voice prompts, videos, music, or the like). In some cases, the audio systems are configured to output optimized or “high-quality” audio content. For instance, acoustic parameters such as the equalization or the dynamics of the audio content can be adjusted to produce the high quality audio content. However, such audio systems can be impacted by various noises around the audio system. For example, noise generated by appliance components can interfere with a consumers ability to hear audio content output by the audio system.

Accordingly, a domestic appliance with improved features that would obviate one or more of the above mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a domestic appliance is provided. The domestic appliance may include an audio system. The audio system may include a speaker and a microphone. The domestic appliance may include a controller in operative communication with the audio system. The controller may be configured to direct a responsive audio operation. The responsive audio operation may include directing operation of the audio system. The responsive audio operation may include determining noise produced during operation of appliance components. The responsive audio operation may include implementing a responsive action at the audio system to adjust acoustic parameters of the audio system in response to determining noise produced during operation of appliance components

In another exemplary aspect of the present disclosure, a method of operating an audio system of a domestic appliance is provided. The method may include directing operation of the audio system. The method may include determining noise produced during operation of appliance components. The method may include implementing a responsive action at the audio system to adjust acoustic parameters of the audio system in response to determining noise produced during operation of appliance components

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to one or more exemplary embodiments of the present subject matter with doors thereof shown in a closed position.

FIG. 2 provides a perspective view of the exemplary refrigerator appliance with doors thereof shown in an open position.

FIG. 3 provides a close-up view of a control panel and a dispensing assembly of the refrigerator appliance of FIG. 1.

FIG. 4 provides a top, perspective view of the example dispensing assembly of FIG. 3 with a control panel removed according to an exemplary embodiment of the present subject matter.

FIG. 5 provides a bottom, perspective view of the example dispensing assembly of FIG. 3 with the control panel removed according to an exemplary embodiment of the present subject matter.

FIG. 6 provides another perspective view of the example dispensing assembly of FIG. 3 with the control panel removed according to an exemplary embodiment of the present subject matter.

FIG. 7 provides a perspective view of a speaker housing of the example dispensing assembly of FIG. 3 with the control panel removed according to an exemplary embodiment of the present subject matter.

FIG. 8 provides a perspective view of the example dispensing assembly of FIG. 3 with a control panel removed according to an exemplary embodiment of the present subject matter.

FIG. 9 provides a perspective view of the example dispensing assembly of FIG. 3 with a control panel removed according to an exemplary embodiment of the present subject matter.

FIG. 10 provides a flow chart illustrating a method of operating an audio system of a domestic appliance according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Embodiments of the present subject matter provide an audio system for a domestic appliance. The audio system may include a speaker assembly and a microphone. The audio system may be operable for playing audio content (e.g., music, audiobook, voice prompts, or the like), for instance, via the speaker assembly. Additionally or alternatively, the audio system may be operable for receiving voice commands (e.g., from a consumer of the domestic appliance), for instance, via the microphone.

Notably, the audio system of the present subject matter is capable of advantageously dynamically adjusting acoustic parameters of audio content output or received by the audio system. In particular, noise profiles for one or more appliance components may be obtained. The noise profiles correspond to acoustic parameters of audio (e.g., noise or sounds) emitted from the one or more appliance components during operation thereof. During audio content playback at the audio system, audio functions (e.g., gain functions, equalization functions, or the like) can be applied to audio content signals (e.g., electrical signals such as audio signals corresponding to the audio content) to advantageously boost or cut certain audio frequencies. The audio functions applied to the audio content signals can advantageously improve the quality of audio content play back (e.g., for the user of the domestic appliance).

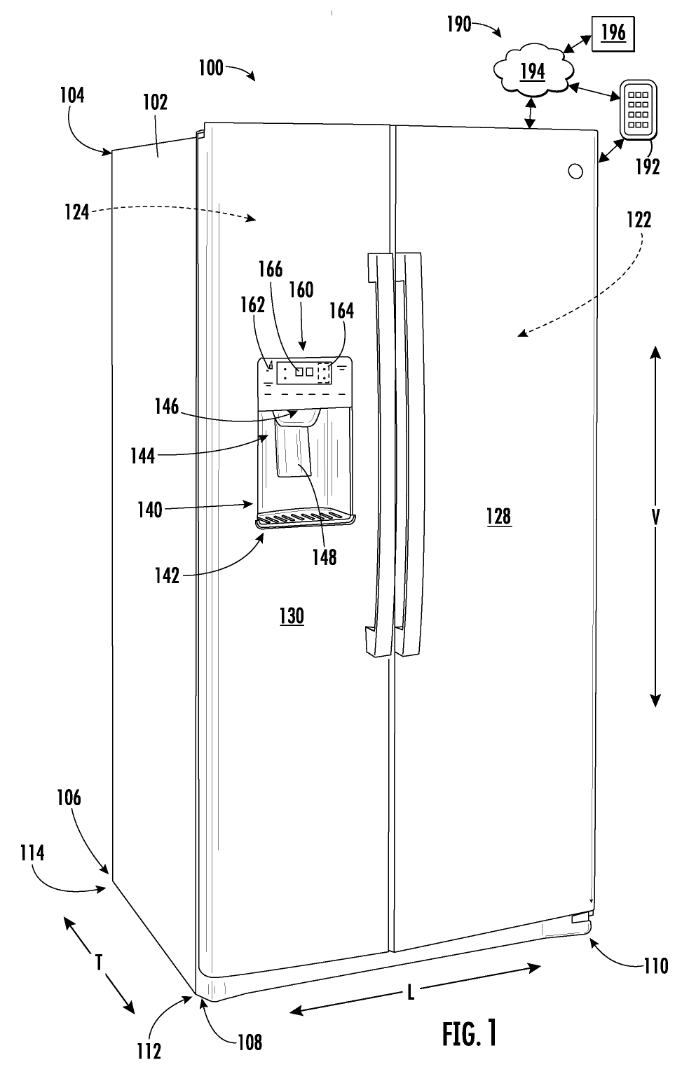

FIG. 1 provides a perspective view of a refrigerator appliance 100 according to an exemplary embodiment of the present subject matter. Refrigerator appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another.

Cabinet 102 defines chilled chambers for receipt of food items for storage. In particular, cabinet 102 defines fresh food chamber 122 positioned at or adjacent second side 110 of cabinet 102 and a freezer chamber 124 arranged at or adjacent first side 108 of cabinet 102. As such, refrigerator appliance 100 is generally referred to as a side-by-side refrigerator. It is recognized, however, that the benefits of the present disclosure apply to other types and styles of refrigerator appliances such as, e.g., a top mount refrigerator appliance, a bottom mount refrigerator appliance, or a single door refrigerator appliance. In addition, it is recognize that the benefits of the present disclosure apply to other types and styles of domestic appliances such as laundry appliances (e.g., washing machine appliance or dryer appliances), kitchen appliance (e.g., oven appliances, microwave appliances, dishwasher appliances), air conditioners, water heaters, or the like. Consequently, the description set forth herein is for illustrative purposes only and is not intended to be limiting in any aspect to any particular refrigerator chamber configuration or domestic appliance.

A refrigerator door 128 is rotatably hinged to an edge of cabinet 102 for selectively accessing fresh food chamber 122. In addition, a freezer door 130 is rotatably hinged to an edge of cabinet 102 for selectively accessing freezer chamber 124. Refrigerator door 128 and freezer door 130 are shown in the closed configuration in FIG. 1. One skilled in the art will appreciate that other chamber and door configurations are possible and within the scope of the present invention.

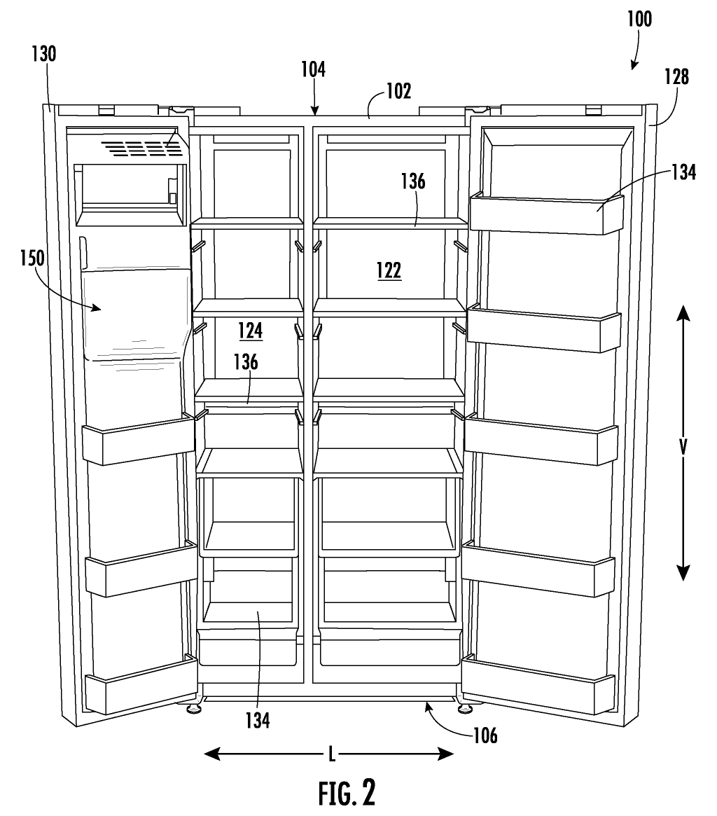

FIG. 2 provides a perspective view of refrigerator appliance 100 shown with refrigerator door 128 and freezer door 130 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages or solid food items) and may assist with organizing such food items. As illustrated, bins 134 may be mounted on refrigerator door 128 and freezer door 130 or may slide into a receiving space in fresh food chamber 122 or freezer chamber 124. It should be appreciated that the illustrated storage components are used only for the purpose of explanation and that other storage components may be used and may have different sizes, shapes, and configurations.

Referring now generally to FIG. 1, a dispensing assembly 140 will be described according to exemplary embodiments of the present subject matter. Dispensing assembly 140 is generally configured for dispensing liquid water or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on freezer door 130. In this regard, dispenser recess 142 is defined on a front side 112 of refrigerator appliance 100 such that a user may operate dispensing assembly 140 without opening freezer door 130. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142.

As shown in FIG. 2, inside refrigerator appliance 100, freezer door 130 may define an icebox 150 housing an icemaker and an ice storage bin that are configured to supply ice to dispenser recess 142. In this regard, for example, icebox 150 may define an ice making chamber for housing an ice making assembly, a storage mechanism, and a dispensing mechanism. Illustration and discussion of these features are omitted here for brevity.

A control panel 160 is provided for controlling the mode of operation. For example, control panel 160 includes one or more selector inputs 162, such as knobs, buttons, touchscreen interfaces, etc., such as a water dispensing button and an ice-dispensing button, for selecting a desired mode of operation such as crushed or non-crushed ice. In addition, inputs 162 may be used to specify a fill volume or method of operating dispensing assembly 140. In this regard, inputs 162 may be in communication with a processing device or controller 164. Signals generated in controller 164 operate refrigerator appliance 100 and dispensing assembly 140 in response to selector inputs 162. Additionally, a display 166, such as an indicator light or a screen, may be provided on control panel 160. Display 166 may be in communication with controller 164, and may display information in response to signals from controller 164.

As used herein, “processing device” or “controller” may refer to one or more microprocessors or semiconductor devices and is not restricted necessarily to a single element. The processing device can be programmed to operate refrigerator appliance 100 and dispensing assembly 140. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions or data that when executed by the processing device, cause the processing device to perform operations.

Referring to FIG. 1, a schematic diagram of an external communication system 190 will be described according to an exemplary embodiment of the present subject matter. In general, external communication system 190 is configured for permitting interaction, data transfer, and other communications between refrigerator appliance 100 and one or more external devices. For example, this communication may be used to provide and receive operating parameters, user instructions or notifications, performance characteristics, user preferences, audio content, or any other suitable information for improved performance of refrigerator appliance 100. In addition, it should be appreciated that an external communication system 190 may be used to transfer data or other information to improve performance of one or more external devices or appliances or improve user interaction with such devices.

For example, external communication system 190 permits controller 160 of refrigerator appliance 100 to communicate with a separate device external to refrigerator appliance 100, referred to generally herein as an external device 192. As described in more detail below, these communications may be facilitated using a wired or wireless connection, such as via a network 194. In general, external device 192 may be any suitable device separate from refrigerator appliance 100 that is configured to provide or receive communications, information, data, or commands. The external device 192 may be a personal phone, a smartphone, a tablet, a laptop or personal computer, a wearable device, a smart home system, or the like configured to provide or receive communication, information, data, or commands from a user. Additionally or alternatively, the external device 192 may be a connected appliance (e.g., a domestic appliance in operative communication with the refrigerator appliance) configured to provide or receive communication, information, data or commands to the refrigerator appliance 100.

In addition, a remote server 196 may be in communication with refrigerator appliance 100 or external device 192 through network 194. In this regard, for example, remote server 196 may be a cloud-based server 196, and is thus located at a distant location, such as in a separate state, country, etc. According to an exemplary embodiment, external device 192 may communicate with a remote server 196 over network 194, such as the Internet, to transmit/receive data or information, provide user inputs, receive user notifications or instructions, interact with or control refrigerator appliance 100, etc. In addition, external device 192 and remote server 196 may communicate with refrigerator appliance 100 to communicate similar information.

In general, communication between refrigerator appliance 100, external device 192, remote server 196, or other user devices or appliances may be carried using any type of wired or wireless connection and using any suitable type of communication network, non-limiting examples of which are provided below. For example, external device 192 may be in direct or indirect communication with refrigerator appliance 100 through any suitable wired or wireless communication connections or interfaces, such as network 194. For example, network 194 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), or protection schemes (e.g., VPN, secure HTTP, SSL).

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

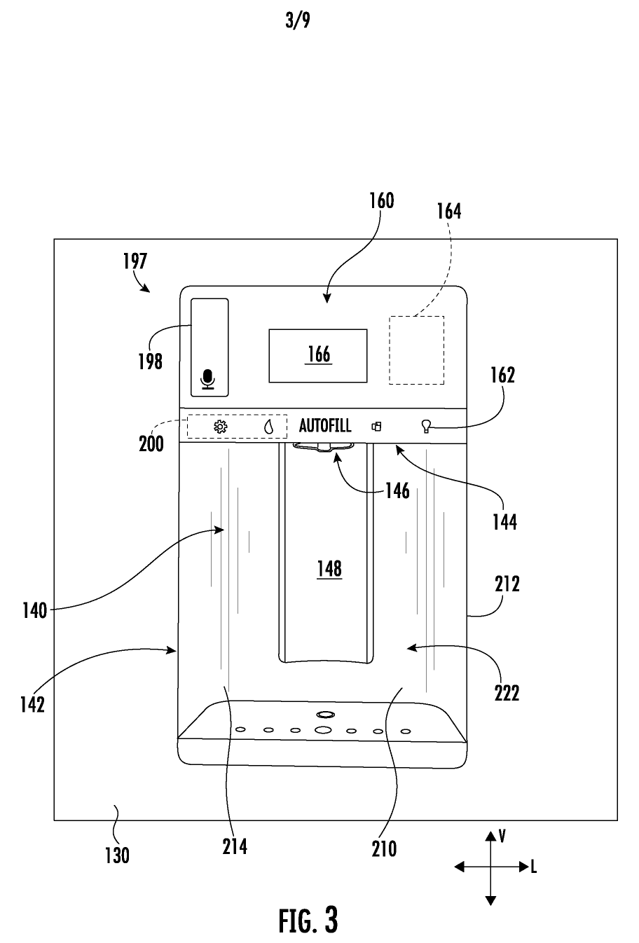

Referring now to FIG. 3 provides a close-up view of the control panel 160 and the dispensing assembly 140 of the refrigerator appliance 100 according to one or more exemplary embodiments of the present subject matter. The refrigerator appliance 100 may include an audio system 197 configured for receiving and playing back high-quality audio content (e.g., voice prompts, music, audiobooks, or the like). The audio system 197 may include one or more microphones or microphone modules 198. The microphone 198 may be any type of device suitable for capturing sound or audio (e.g., as a sound recording) within the room containing refrigerator appliance 100. As an example, microphone 198 may include or be provided as a dynamic microphone, ribbon microphone, fiber-optic microphone, piezoelectric microphone. When assembled, microphone 198 is in communication (e.g., electric or wireless communication) with controller 164. As is understood, the microphone 198 may generate one or more electrical signals (e.g., to be received by controller 164) from one or more received soundwaves (e.g., from appliance components, such as during an operational state of the appliance component).

In addition, it should be appreciated that any suitable number, type, position, and configuration of microphones may be used while remaining within the scope of the present subject matter. For example, according to the illustrated embodiment, a single microphone 198 is mounted to refrigerator door 128 for monitoring sounds and voices around refrigerator appliance 100 (e.g., within the kitchen, dining room, etc.). As described herein, detected sounds and voices may be used to improve user interaction and control of refrigerator appliance 100. However, according to alternative embodiments, microphone 198 could be mounted to any other kitchen appliance or could be a standalone device that is in operative communication with refrigerator appliance 100 to provide feedback regarding a user interaction with refrigerator appliance 100.

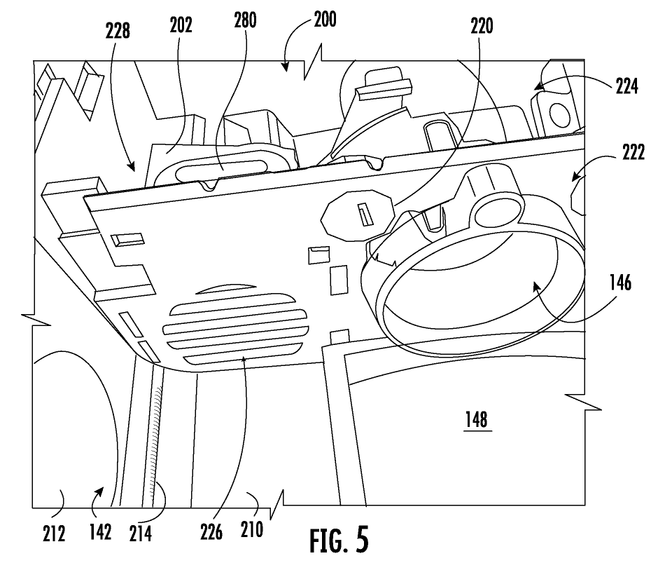

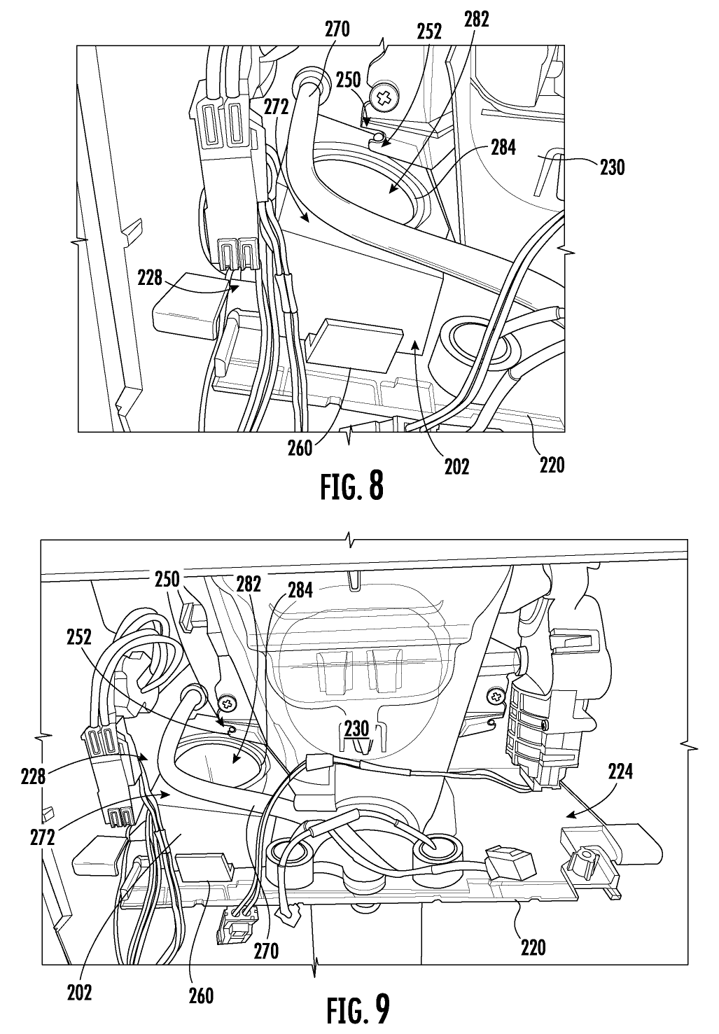

In addition, the audio system 197 may include a speaker assembly 200. Referring now generally to FIGS. 1 through 9, the speaker assembly 200 that may be used with refrigerator appliance 100 will be described according to exemplary embodiments of the present subject matter. Specifically, as will be described in more detail below, speaker assembly 200 and dispenser recess 142 are designed to achieve a desired or targeted acoustic response from a speaker positioned within dispenser recess 142. Notably, conventional refrigerator speakers or audio devices are small, low-power, and limited frequency devices incapable of providing rich audio content as facilitated by a speaker assembly 200. Moreover, conventional refrigerator appliances have limited space for receiving higher-quality speakers and have speakers oriented in a manner that generates less than desirable audio response or sound quality.

According to an example embodiment, speaker assembly 200 may generally include a speaker box or speaker housing 202 that contains a speaker driver 204 including a sound producing speaker cone. According to the illustrated embodiment, speaker assembly 200 is positioned within dispenser recess 142 and is covered up by control panel 160. Specifically, speaker housing 202 may be concealed by control panel 160 for improved aesthetics. In addition to aesthetics, when control panel 160 is in place it further modifies the resulting audio output shaping it into the more desired response. In addition, according to an example embodiment, speaker assembly 200 and the sound producing speaker cone may generally be directed downward along the vertical direction V into dispenser recess 142.

Notably, the downward orientation of speaker assembly 200 may generate some audio issues particularly at boundary frequencies (e.g., such as reduced high/low frequency output or performance). Accordingly, aspects of the present subject matter are generally directed to an improved design of dispenser recess 142 in conjunction with the high-quality speaker assembly 200 to produce a synergistic effect with improved overall audio quality across the entire audible spectrum (e.g., between 20 Hz to about 20 kHz). Although speaker assembly 200 is illustrated and described herein as including a single speaker, it should be appreciated that speaker assembly 200 may include any suitable number, type, configuration, and positioning of speakers while remaining within the scope of the present subject matter.

Specifically, according to the illustrated embodiment, dispenser recess 142 may be specifically designed to facilitate an improved acoustic response from speaker assembly 200. In this regard, the geometry of dispenser recess 142 may act as a parabolic reflector, a sounding board, or a noise reflector particularly suited for improving the frequency response, recovering some of the high frequency output that would normally be lost by orienting the speaker downward and 90 degrees from the axis of the listener, etc. Specifically, according to an example embodiment, dispenser recess 142 may generally be defined by a back wall 210, sidewalls 212, and two arcuate corners 214 that join back wall 210 to sidewalls 212.

Specifically, as illustrated, back wall 210 may generally be a flat wall extending in a plane defined by the vertical direction V and the lateral direction L. Similarly, sidewalls 212 may generally be flat walls extending in a plane defined by the vertical direction V and the transverse direction T. Arcuate corners 214 may wrap around an axis defined by the vertical direction V to join back wall 210 to sidewalls 212. Notably, the orientation of speaker assembly 200 in conjunction with the geometry of dispenser recess 142 may provide a particularly suitable sound response.

Notably, the positioning of speaker assembly 200 within dispenser recess 142 may be important for determining the appropriate sound response of speaker assembly 200. For example, as illustrated, refrigerator appliance 100 may include a separator panel 220 that divides dispenser recess 142 into a dispensing region 222 and a mechanical compartment 224. In this regard, separator panel 220 may generally extend within a horizontal plane (e.g., defined by the lateral direction L and the transverse direction T). Dispensing region 222 may be positioned below separator panel 220, e.g., and may include actuating mechanism 148 and a space for receiving cups. By contrast, mechanical compartment 224 may be positioned above separator panel 220 and may be covered by control panel 160. Speaker assembly 200 may be positioned within mechanical compartment 224 and separator panel 220 may define a plurality of apertures 226 through which sound may pass into dispensing region 222.

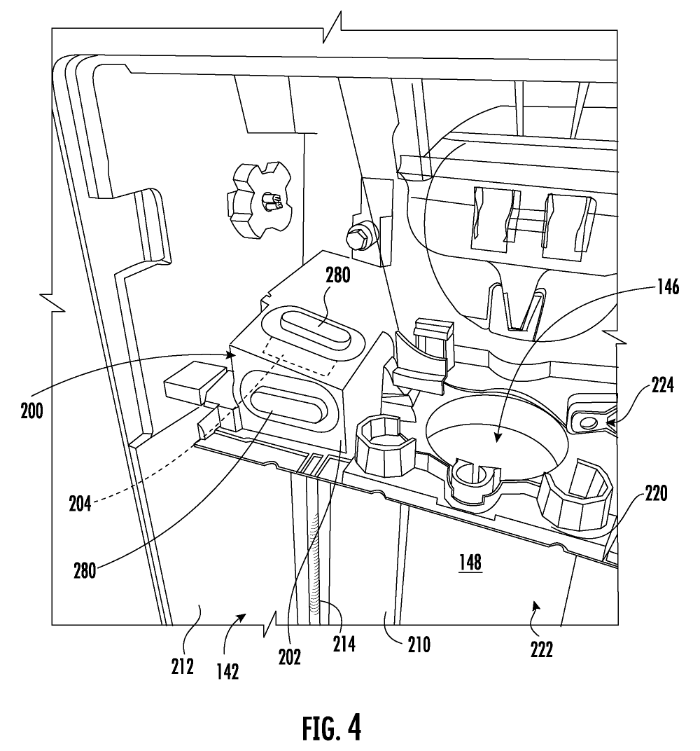

As best illustrated in FIGS. 4 through 9, dispenser recess 142 may generally define a speaker void 228 and speaker assembly 200 may be carefully designed to fit within speaker void 228 while optimizing audio output of speaker assembly 200. In this regard, speaker void 228 may generally be defined by back wall 210, sidewalls 212, arcuate corners 214, control panel 160, separator panel 220, or an ice dispensing funnel 230 (e.g., within mechanical compartment 224). Notably, due to the size restrictions within dispenser recess 142, it may be desirable to maximize the speaker assembly 200 within speaker void 228 for improved sound output. Accordingly, aspects of the present subject matter are directed to a speaker housing 202 and speaker assembly 200 that maximizes speaker performance for the given speaker void 228.

In this regard, for example, speaker housing 202 may generally be defined by a front wall 232, a rear wall 234, a bottom wall 236, a top wall 238, and a plurality of sidewalls 240. The spacing, geometry, angle, and shape of walls (e.g., front wall 232, rear wall, 234, bottom wall 236, top wall 238, or the plurality of sidewalls 240) may be carefully designed or ideal acoustic sizing, reduced vibration, improved assembly, and improved durability of speaker housing 202. For example, front wall 232, rear wall, 234, bottom wall 236, top wall 238, or the plurality of sidewalls 240 may fill the entire speaker void 228 and may improve manufacturability, as described in more detail below according to example embodiments.

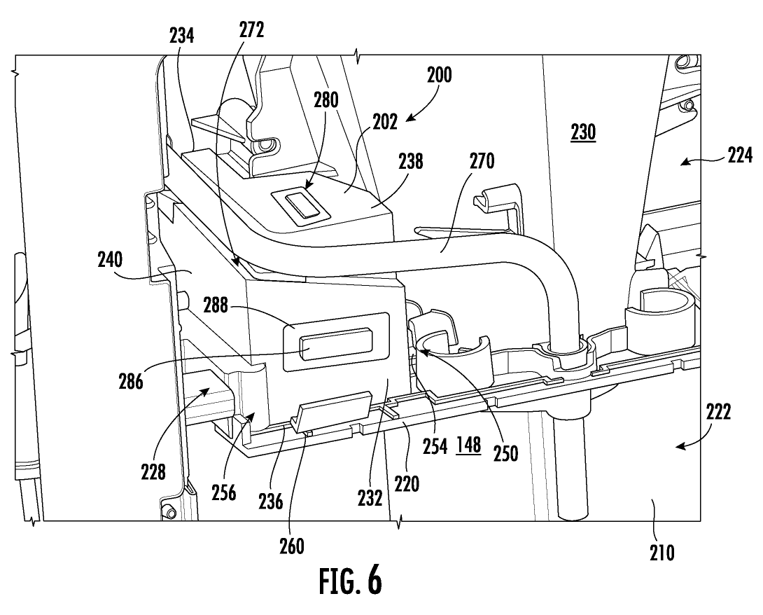

Example, speaker housing 202 may define at least one housing alignment feature 250. In general, housing alignment features 250 may include any suitable geometries, bosses, protrusions, recesses, or extensions to facilitate proper and consistent installation of speaker housing 202. For example, as illustrated in FIGS. 6 through 9, housing alignment feature 250 may include an alignment geometry or recess 252 for engaging a complementary protrusion within dispenser recess 142. For example, alignment recess 252 may be defined within top wall 238 of speaker housing 202 and may be configured for engaging a fastener or alignment feature defined on ice dispensing funnel 230 or a protruding feature within dispenser recess 142.

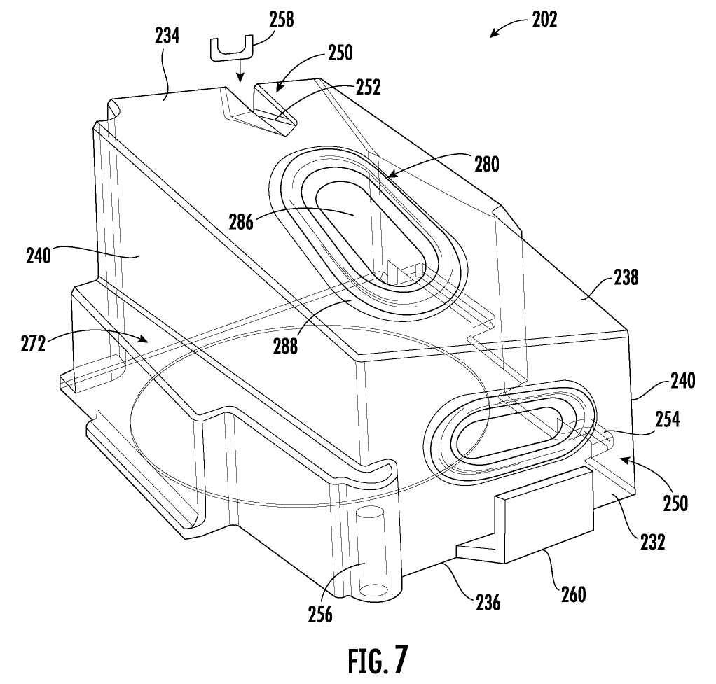

In addition, as shown for example in FIG. 7, housing alignment feature 250 may include a protruding leg 254 that is received within a complementary recess defined on separator panel 220 or ice dispensing funnel 230. In this manner, an installation technician may slide protruding leg 254 into the complementary recess to ensure accurate and repeatable positioning of speaker housing 202. It should be appreciated that other alignment and installation geometries are possible and within the scope of the present subject matter.

According to still other example embodiments, as illustrated in FIGS. 6 and 7, housing alignment feature 250 may include a threaded boss 256 defined through bottom wall 236 of dispenser housing 202. Threaded boss 256 may be configured for receiving a mechanical fastener that passes through separator panel 220 for securing speaker housing 202 within dispenser recess 142. Notably, alignment of alignment recess 252 and protruding leg 254 may properly position speaker housing 202 such that threaded boss 256 is positioned over an attachment aperture defined in separator panel 220 (e.g., such that a mechanical fastener may pass therethrough into threaded boss 256).

As illustrated schematically in FIG. 7, speaker assembly 200 may further include one or more pads, cushions, or vibration dampeners 258 positioned on speaker housing 202 for reducing vibrations, e.g., particularly at locations where speaker housing 202 is contacting other components or surfaces. According to the illustrated embodiment, vibration dampener 258 is positioned within alignment recess 252 to prevent vibration-related noise due to contact between alignment recess 252 and ice dispensing funnel 230. However, it should be appreciated that vibration dampeners 258 may be used on other locations of speaker housing while remaining within the scope of the present subject matter.

Referring now specifically to FIGS. 6 and 7, speaker housing 202 may further define at least one wiring retention feature 260. For example, wiring retention feature 260 may be a clip, groove, or other attachment point sized to receive a bundle of wires or a wiring connector. In this manner, an installation technician may install the wiring harness into the wiring retention feature 260 while installing speaker assembly 200. This wiring harness may remain within wiring retention feature 260 for the lifetime of speaker assembly 200, thereby reducing undesirable vibrations, rubbing, or wear on the wires.

In addition, dispensing assembly 140 may include a water line 270 passing through dispenser recess 142 and speaker housing 202 may define a water line support surface 272. In general, water line 270 is seated on water line support surface 272, which is designed to minimize vibrations and provide a compact and efficient routing of water line 270, e.g., thereby preventing kinks, rubbing, vibrations, etc. Although an example geometry is illustrated, it should be appreciated that this geometry may vary while remaining within the scope of the present subject matter.

As illustrated in FIGS. 4 through 7, speaker assembly 200 may further include one or more passive radiator elements 280. In general, passive radiator elements 280 may be positioned on or within speaker housing 202 to improve the acoustics of speaker assembly 200 (e.g., by boosting low frequency output of speaker assembly 200). For example, as illustrated, speaker housing 202 may define one or more radiator apertures 282 and a support flange 284 that surrounds each of the radiator apertures 282 for receiving the passive radiator elements 280. According to the illustrated embodiments, passive radiator elements 280 include an acoustic diaphragm 286 (e.g., a rubber or metal diaphragm) positioned over the radiator apertures 282 and connected to the support flange 284 through a resilient border 288 (e.g., formed from rubber). Other suitable acoustic radiator constructions are possible and within the scope of the present subject matter.

Notably, speaker assembly 200 may generally have a larger power than conventional refrigerator audio indicators. For example, speaker assembly 200 may have a power level that is greater than 3 watts, greater than 5 watts, or greater, e.g., such as between about 6 and 8 watts. In addition, speaker assembly 200 may be designed to generate a frequency range over the entire audible spectrum, e.g., between about 20 Hz and 20 kHz. For example, speaker assembly 200 may have a frequency range of between about 100 Hz and 18 kHz.

As explained herein, aspects of the present subject matter are generally directed to a compact speaker enclosure designed to fit in the refrigerator door dispenser recess area wherein the speaker is oriented such that the sound-producing cone faces down into the dispenser area. A top surface of the speaker enclosure may be designed to fit a passive radiator. The resulting speaker is capable of producing sound at a reasonable listening level (e.g., 75-77 dB SPL) with a low-frequency cutoff of around 140 Hz. The design may also incorporate features for routing and securing wiring to control and prevent vibration. Additionally, a recessed geometry boss may also be present that pushes the speaker down to minimize vibration.

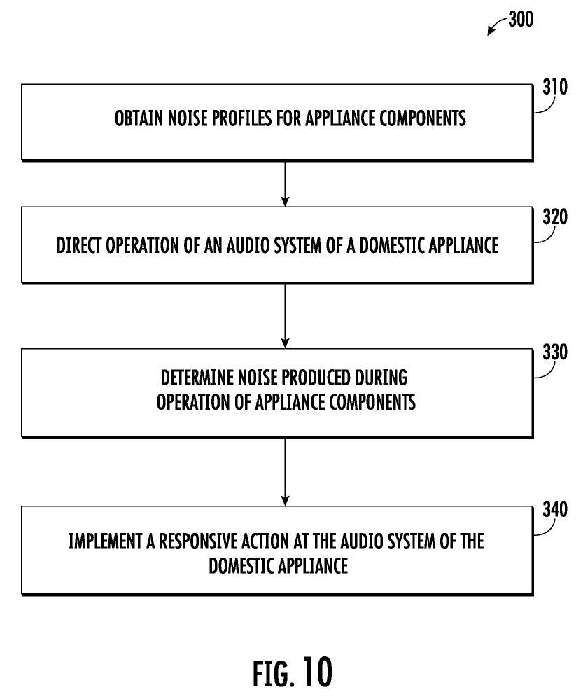

Now that the construction and configuration of refrigerator appliance 100 has been presented according to an exemplary embodiment of the present subject matter, an exemplary method for operating an audio system of a refrigerator appliance is provided. Referring now to FIG. 10, a method 300 may be provided for operating an audio system of a domestic appliance according to one or more exemplary embodiments of the present subject matter. Method 300 can be used to operate the audio system 197 of the refrigerator appliance 100, or to operate any other suitable audio system for a domestic appliance. In this regard, for example, a controller such as controller 164 may be configured for implementing method 300, and more particularly, for directing a responsive audio operation. However, it should be appreciated that the exemplary method 300 is discussed herein only to describe exemplary aspects of the present subject matter, and is not intended to be limiting.

FIG. 10 depicts steps performed in a particular order for the purpose of illustration and discussion. Those of ordinary skill in the art, using the disclosures provided herein, will understand that (except as otherwise indicated) the steps of any of the methods disclosed herein can be modified, adapted, rearranged, omitted, or expanded in various ways without deviating from the scope of the present disclosure.

At 310, the method 300 includes obtaining noise profiles for one or more appliance components. As used herein, “noise profile” may generally refer to acoustic parameters of a noise produced by the appliance component when the appliance component is in an operational state. For example, the noise profile of an appliance component may include frequency components of the noise produced by the appliance component when the appliance component is functional (e.g., fully or partially) and active. Frequency components of noise correspond to the number of times per second that the sound wave of the noise repeats itself. In general, frequency refers to how high- or low-pitched the noise is. For instance, lower frequencies correspond to deeper or lower tones. Higher frequencies correspond to higher or sharper tones. As another example, the noise profile of the appliance component may include amplitude components of the noise produced by the appliance component when the appliance component is functional (e.g., fully or partially) and active. Amplitude of noise corresponds to the strength or loudness of the noise. The amplitude of a noise may be directly proportional to a height of the sound wave of the noise.

The appliance components may include components of the domestic appliance. For example, the appliance components may include mechanically driven or electrically driven components of a domestic appliance such as a pump, compressor, motor, icemaker, or the any other suitable appliance component that may produce noise during an operational state thereof. Additionally or alternatively, the appliance components may include components (e.g., mechanically driven or electrically driven components) of a connected appliance. For example, the connected appliance may be a domestic appliance that is in operative communication with the domestic appliance, for instance, via an external communication system. In addition, the connected appliance may be within a predetermined audible range of the domestic appliance. The predetermined audible range may be a predetermined area or location around the domestic appliance wherein a user may be capable of hearing audio content emitted from the audio system of the domestic appliance.

Obtaining the noise profiles may include recording noise or sound produced by the appliance components during an operational state of the appliance components. In some instances, the noise or sound may be recorded prior to installation of the domestic appliance such as during production or manufacturing of the domestic appliance. For example, prior to installation of the domestic appliance, an operator of the domestic appliance may selectively direct operation of the appliance component(s), for instance, at a predetermined operational state (e.g., on/off operational state, an intermediate operational state, or the like). A microphone may be used to record the noise or sound produced during the directed operation of the appliance component(s). The microphone used to record the noise or sound may be a microphone positioned at a height approximating a user’s listening height (e.g., the average ear height of a user that is standing or the average ear height of a user that is sitting). For example, a microphone external to the domestic appliance positioned at a height approximate a user’s listening height may be used to record the noise or sound produced by the appliance component.

In some other instances, the noise or sound may be recorded after installation of the domestic appliance, such as prior to directing operation of the audio system (e.g., at 320 described in more detail below). For example, after installation of the domestic appliance, a calibration cycle can be performed for the audio system. During the calibration cycle, one or more appliance components may be selectively operated or activated. In some instances, the appliance components are selectively operated or activated in a sequential order (e.g., corresponding to a calibration list stored within the memory of the controller). During the operational state of each appliance component, the microphone of the audio system may be utilized to record the noise or sound produced by the appliance component. For example, the audio system may record noise or sound produced by the appliance components in the human hearing range. In general the human ear can detect frequencies ranging from approximately 20 hertz (Hz) to approximately 20 kilohertz (kHz). In addition, the human can detect amplitudes from approximately 0 decibels (dB) to approximately 130 dB.

As should be appreciated, the microphone may convert the noise or sound into appliance load signals (e.g., electronic representations of sounds waves corresponding to the noise or sound). The controller may then store the appliance load signals may be stored within a memory thereof. Thus, obtaining the noise profiles may include storing the appliance load signals within a memory of the controller, for instance, upon recording the noise produced by the appliance component. In this regard, appliance load signals for each appliance component (e.g., of the domestic appliance or a connected domestic appliance) obtained and stored to the memory of the controller.

In addition, obtaining the noise profiles may include determining acoustic parameters (e.g., amplitude, frequency, time period, velocity, or any other suitable parameter) based on the appliance load signals stored within the memory. Determining acoustic parameters may include analyzing the appliance load signals. The appliance load signals may be analyzed in response to, or upon, storing the appliance load signals within the memory of the controller. The appliance load signals may be analyzed via any suitable means that is capable of obtaining acoustic parameters of the appliance load signals. For example, the appliance load signals may be analyzed (e.g., processed) using a Fast Fourier Transform (FFT). The FFT may convert the stored appliance load signals into the individual spectral components (e.g. frequency and amplitude) of the appliance load signals. As another example, the appliance load signals may be analyzed using octave bands (e.g., one-one octave band analysis or one-third octave band analysis) to filter or break down the appliance load segments into smaller segments (e.g., octaves) to obtain different noise levels at specific frequencies. Thereby, noise profiles for one or more appliance components may be obtained.

At 320, the method 300 may include directing operation of the audio system of the domestic appliance. Directing operation of the audio system may include receiving consumer audio signals (e.g., input audio signals such as voice commands) at the microphone.

Additionally or alternatively, directing operation of the audio system of the domestic appliance may include outputting (e.g., playing) audio content (e.g., music, audiobooks, voice prompts, message indicators, or the like) at a speaker assembly of the audio system. For instance, the speaker assembly may convert the received audio content signals to the mechanical energy representative of the audio content. The speaker assembly may output the audio content at default audio parameters. The default audio parameters may correspond to preset or predetermined frequency or amplitude components of the audio content.

In some instances, prior to output of the audio content, the controller may receive audio content signals (e.g., electrical signals corresponding to the audio content to be output by the speaker assembly), for instance, from an external device in operative communication with the domestic appliance. For example, a user of the domestic appliance may wish to playback audio content at the speaker assembly. The user may manipulate an external device (e.g., a smartphone, smartwatch, tablet, or the like in operative communication with the domestic appliance) to transmit the audio content signals to the controller.

In some other instances, the audio content signals may be received from audio content signals corresponding to voice prompts (e.g., indicators or messages) may be received from one or more electrically driven components of the domestic appliance, for instance, in response to user manipulation of the domestic appliance, a time-out condition of the domestic appliance, or the like.

At 330, the method 300 may include determining noise produced during operation of one or more appliance components following directing operation of the audio system. Noise produced during operation of appliance components may generally refer to at least a discernible amount of noise in the human hearing range that is produced by the appliance component during operation thereof. The controller may be configured to periodically or continuously receive, monitor, and obtain operational data of appliance components (e.g., appliance components of the domestic appliance or appliance components of connected domestic appliances). The operation data may correspond to operational states of the appliance component (e.g., on/off operational states, intermediate operational states, or the like). Thus, the controller, at 330, may detect when one or more appliance components are operational and is producing noise.

At 340, the method 300 may include implementing a responsive action at the audio system of the domestic appliance. The responsive action may be implemented in response to, or upon, detecting operation of one or more appliance components during operation of the audio system. Implementing the responsive action at the audio system may include adjusting acoustic parameters of audio content signals (e.g., corresponding to audio content that is to be output at the speaker assembly). In particular, based on the noise profile of the operational appliance component(s) (e.g., obtained at 310), the acoustic parameters of the audio content signal may be adjusted, for instance, to advantageously boost or cut certain acoustic parameters of the audio content signal.

Adjusting the acoustic parameters of the audio content signal may include applying an audio function to the audio content signal. The audio functions applied to the audio content signal may generally process or manipulate the audio content signals to enhance or modify the audio content signals. The audio function may include a gain function, for instance, to adjust an amount of amplification applied to the audio content signal. In particular, when the gain function is applied to the audio content signal a tone of the audio content output at the speaker assembly may be adjusted. The audio function may include an equalization function. The equalization function may adjust a frequency balance of the audio content signal, for instance, by boosting or cutting specific frequencies of the audio content signal. The audio function may include a compression function. The compression function may alter the overall dynamic range of the audio content signal, for instance, by reducing differences in volume between the quietest and loudest parts of the audio content signal.

The audio function applied to the audio content signal may be based on the noise profile of the operational appliance component(s). For example, when the operational appliance component(s) are emitting a discernible amount of noise, the audio function may be applied to boost an overall volume level of audio system. Boosting the overall volume level of audio systems may include increasing the amplitude of the audio content signal being output. As another example, when the noise profile of the operational appliance component(s) includes audio signals in a target frequency ranges (e.g., frequency ranges of the audio content), the audio function may be applied to amplify (e.g., increase the magnitude of) the target frequency ranges of the audio content signal. In this regard, the noise emitted by the operational appliance component(s) may be masked (e.g., to a listener of the audio content). As yet another example, when the operational appliance component(s) are emitting an amount of noise that is loud (e.g., louder than a volume level of the audio content), the audio function may be applied to filter out frequencies in a component range (e.g., a frequency range corresponding to the noise profile of the operational appliance component(s)). Additionally or alternatively, the audio function may be applied to boost frequency ranges outside of the component range. In this regard, the frequency ranges outside of the component range may be heard (e.g., to a listener of the audio content).

Additionally or alternatively, implementing the responsive action at the audio system may include adjusting, at a controller such as the controller of the domestic appliance or a controller of the microphone, acoustic parameters of a consumer audio signal (e.g., voice commands from the consumer) received at the microphone of the audio system. The adjustments to the consumer audio signal may be based on the noise profiles of the operational appliance component(s). For instance, frequencies ranges corresponding to component frequencies ranges (e.g., frequency ranges contained within noise profiles of the operational appliance component(s)) may cut or removed from consumer audio signals (e.g., voice commands from the consumer) received at the microphone. Notably, adjusting the consumer audio signal advantageously increases speech recognition abilities of the audio system. For instance, adjusting the microphone may improve the quality (e.g., the clarity) of the consumer audio signals received at the controller. In this regard, the controller’s ability to recognize and interpret human speech (e.g., voice commands) may be improved.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A domestic appliance comprising:
an audio system, the audio system comprising a speaker and a microphone;
and
a controller in operative communication with the audio system, the controller being configured to direct a responsive audio operation, the responsive audio operation comprising:
directing operation of the audio system,
determining noise produced during operation of appliance components, and
implementing a responsive action at the audio system to adjust acoustic parameters of the audio system in response to determining noise produced during operation of appliance components.

2. The domestic appliance of claim 1, wherein the responsive audio operation further comprises:
receiving appliance load signals prior to directing operation of the audio system, the appliance load signals corresponding to noise produced by the appliance components during noise producing operation of the appliance components,
storing the appliance load signals within a memory, and
determining acoustic parameters based on the appliance load signals.

3. The domestic appliance of claim 2, wherein determining acoustic parameters based on the appliance load signals comprises processing the appliance load signals with a Fast Fourier Transform.

4. The domestic appliance of claim 1, wherein the appliance components comprise at least one pump, motor, valve, diaphragms, fans, or compressor of the domestic appliance.

5. The domestic appliance of claim 1, wherein the appliance components comprise mechanically driven or electrically driven components of a connected appliance that emits noise during operation, and
wherein the connected appliance includes an appliance in operative communication with the domestic appliance.

6. The domestic appliance of claim 1, wherein directing operation of the audio system comprises
directing a speaker assembly of the audio system to output audio content.

7. The domestic appliance of claim 6, wherein implementing the responsive action at the audio system comprises
adjusting, based on a noise profile of the appliance components, the acoustic parameters of an audio content signal,
wherein the audio content signal corresponds to the audio content output at the audio system.

8. The domestic appliance of claim 7, wherein adjusting the acoustic parameters of the audio content signal comprises
applying an audio function configured to adjust to the audio content signal.

9. The domestic appliance of claim 1, wherein directing operation of the audio system comprises
receiving consumer audio signals at the microphone.

10. The domestic appliance of claim 9, wherein implementing the responsive action at the audio system comprises
adjusting, based on a noise profile of the appliance components, acoustic parameters of the consumer audio signals.

11. A method of operating an audio system of a domestic appliance, the method comprising:
directing operation of the audio system,
determining noise produced during operation of appliance components, and
implementing a responsive action at the audio system to adjust acoustic parameters of the audio system in response to determining noise produced during operation of appliance components.

12. The method of claim 11, further comprising:
receiving appliance load signals prior to directing operation of the audio system, the appliance load signals corresponding to noise produced by the appliance components during noise producing operation of the appliance components,
storing the appliance load signals within a memory, and
determining acoustic parameters based on the appliance load signals.

13. The method of claim 12, wherein determining acoustic parameters based on the appliance load signals comprises processing the appliance load signals with a Fast Fourier Transform.

14. The method of claim 11, wherein the appliance components comprise at least one pump, motor, valve, diaphragms, fans, or compressor of the domestic appliance.

15. The method of claim 11, wherein the appliance components comprise mechanically driven or electrically driven components of a connected appliance that emits noise during operation, and
wherein the connected appliance includes an appliance in operative communication with the domestic appliance.

16. The method of claim 11, wherein directing operation of the audio system comprises
directing a speaker assembly of the audio system to output audio content.

17. The method of claim 16, wherein implementing the responsive action at the audio system comprises
adjusting, based on a noise profile of the appliance components, the acoustic parameters of an audio content signal,
wherein the audio content signal corresponds to the audio content output at the audio system.

18. The method of claim 17, wherein adjusting the acoustic parameters of the audio content signal comprises
applying an audio function configured to adjust to the audio content signal.

19. The method of claim 11, wherein directing operation of the audio system comprises
receiving consumer audio signals at the microphone.

20. The method of claim 19, wherein implementing the responsive action at the audio system comprises
adjusting, based on a noise profile of the appliance components, acoustic parameters of the consumer audio signals.
